(19) United States
(12) Patent Application Publication
(10) Pub. No.: US 2004/0066538 A1
(43) Pub. Date: Apr. 8, 2004

(54) Conversion of halftone bitmaps to continuous tone representations

(76) Inventor: William A. Rozzi, Stillwater, MN (US)

Correspondence Address: SHUMAKER & SIEFFERT, P. A., 8425 SEASONS PARKWAY, SUITE 105, ST. PAUL, MN, 55125, US

(21) Appl. No.: 10/266,095

(22) Filed: Oct. 4, 2002

(51) Int. Cl. H04N 1/40; H04N 1/405; H04N 1/409; G06T 5/00; G06K 9/34; G06K 9/46; G06T 7/00; G06T 5/40

(52) U.S. Cl. 358/2.1; 358/3.08; 358/3.26; 358/462; 358/3.2; 382/171; 382/176; 382/197; 382/204; 382/224; 382/156; 358/406

(57) ABSTRACT

Techniques for converting images defined by halftone bitmaps to continuous tone (CT) representations can better preserve geometric information from the original halftone bitmaps, enhancing the accuracy of CT proofs produced by lower resolution proofers such as inkjet and electrophotographic devices. The conversion techniques may involve the application of different conversion processes to text/linework and image regions of the bitmaps. For example, the conversion process for image regions may involve application of bandwidth limitation to remove halftone dot structures prior to downsampling. On the contrary, the conversion process for text/linework regions may exclude bandwidth limitation in order to preserve sharpness of text and linework. The conversion techniques may use a variety of analysis modes to distinguish text and image regions such as connected component analysis to identify regions of contiguous pixels, followed by pixel count analysis, histogram analysis, or a combination thereof, to classify the connected components as either text/linework or imagery.

### FIELD

The invention relates to color imaging and, more particularly, to techniques for manipulating color image data for use with different types of imaging devices.

### BACKGROUND

High-resolution halftone bitmaps generated by graphic arts raster image processors (RIPS) typically serve as the data source for generation of lithographic printing plates. Often, it is desirable to view color proofs before preparation of printing plates used to print an image on a high-volume printing press. However, making proofs using high-resolution halftone bitmaps can be an expensive process in terms of both hardware and media. In addition, the high-resolution halftone proofing process can be quite time consuming, sometimes requiring up to one hour or more for completion of each proof.

Less expensive proofers, such as inkjet and electrophotographic devices, can produce proofs more quickly and provide reasonable color accuracy. Unfortunately, such proofs ordinarily rely on lower-resolution, continuous tone output from an alternate pass through a RIP, which can result in artifacts and loss of geometric information. For example, conversion from halftone to continuous tone can introduce artifacts like moiré that are visible in the resulting continuous tone proof and undermine the accuracy of the proof. Accordingly, it has been difficult to produce proofs from high-resolution halftone bitmaps in a cost-effective and timely manner while maintaining desirable image accuracy.

### SUMMARY

The invention is directed to techniques for converting images defined by halftone bitmaps to continuous tone (CT) representations. The conversion techniques are designed to better preserve continuous tone geometric information from the halftone bitmaps, enhancing the accuracy of CT proofs produced by lower resolution proofers, such as inkjet and electrophotographic devices. To better preserve geometric information, and thereby promote image accuracy, the conversion techniques may involve the application of different conversion processes to “text/linework” and image regions of the page defined by the original halftone bitmap. The term “text/linework” region, as used herein, refers to a region of an image that contains either text or linework, or both.

For example, the conversion process for image regions may involve application of bandwidth limitation, e.g., a blur filter, to remove halftone dot structures prior to downsampling. On the contrary, the conversion process for text/linework regions may exclude bandwidth limitation in order to avoid introduction of fuzziness to text and linework.

The conversion techniques may use a variety of analysis modes to distinguish text and image regions of a page. The techniques may involve, for example, connected component analysis to identify regions of contiguous pixels, followed by pixel count analysis, histogram analysis, or a combination thereof to classify the connected components as either a text or image region. Other techniques such as Bayesian and neural network-based classification may be used.

In addition, the techniques may involve a determination of the type of screening applied to a given halftone bitmap. For first order stochastic screening, the techniques may apply a common conversion process to the entire image without identification of text/linework and image regions. For second order stochastic and conventional screening, i.e., random and periodic clustered-dot halftones, however, the techniques may identify text/linework and image regions and apply different conversion processes.

In one embodiment, the invention provides a method comprising identifying text and image regions defined by a halftone bitmap, converting the text region to a first continuous tone representation using a first conversion process, and converting the image region to a second continuous tone representation using a second conversion process.

In another embodiment, the invention provides a computer-readable medium comprising instructions to cause a processor to identify text and image regions defined by a halftone bitmap, convert the text region to a first continuous tone representation using a first conversion process, and convert the image region to a second continuous tone representation using a second conversion process.

In an additional embodiment, the invention provides a printing device comprising a processor to identify text and image regions defined by a halftone bitmap, convert the text region to a first continuous tone representation using a first conversion process, and converting the image region to a second continuous tone representation using a second conversion process, and a print engine that forms an image on image output medium based on the first and second continuous tone representations.

The invention can provide one or more advantages. For example, in some embodiments, the invention may provide conversion techniques that permit the use of high-resolution halftone bitmaps to drive lower resolution continuous tone devices while preserving geometric information in image regions and sharpness in text/linework regions. In this manner, lower resolution proofers can rely on conversion of the original halftone bitmaps, and thereby avoid the need for multiple RIPs. In particular, retaining more of the geometric information from halftone bitmaps in inkjet or electrophotographic proofs can increase the utility of continuous tone proofing, and produce lower proofing costs.

In addition, a conversion process that reduces introduction of moiré or other artifacts can enable lower resolution continuous tone printing devices to be delivered without RIPs. Instead, the printing devices can simply provide conversion from halftone to continuous tone, with color management, and thereby rely on device control functionality to form the proofs. Consequently, in some embodiments, the invention may support RIP-less printing devices that offer a RIP-once, output-many workflow in which halftone bitmaps serve as a standard interchange format, e.g., for proofing applications.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 is a block diagram of an example proofing system that converts halftone bitmaps to continuous tone representations.

FIG. 2 is a flow diagram illustrating conversion of halftone bitmaps to continuous tone representations using different conversion processes for text/linework and image regions.

FIG. 3 is a flow diagram illustrating the conversion technique of FIG. 2 in further detail.

FIGS. 4A and 4B are diagrams illustrating manually and automatically determined decision boundaries in a two-dimensional feature space.

FIG. 5 is a flow diagram illustrating application of connected component analysis and pixel counting to distinguish text/linework regions and image regions.

FIG. 6 is a flow diagram illustrating application of connected component analysis and histogram analysis to distinguish text/linework regions and image regions.

FIG. 7 is a flow diagram illustrating application of connected component analysis and Bayesian classification to distinguish text/linework regions and image regions.

FIGS. 8A-8C are diagrams illustrating application of connected component analysis to an exemplary image.

FIG. 9 is a graph illustrating normalized histograms for connected components in an exemplary image.

FIG. 10 is a graph illustrating radially-averaged FFT samples used to distinguish halftone screening types.

### DETAILED DESCRIPTION

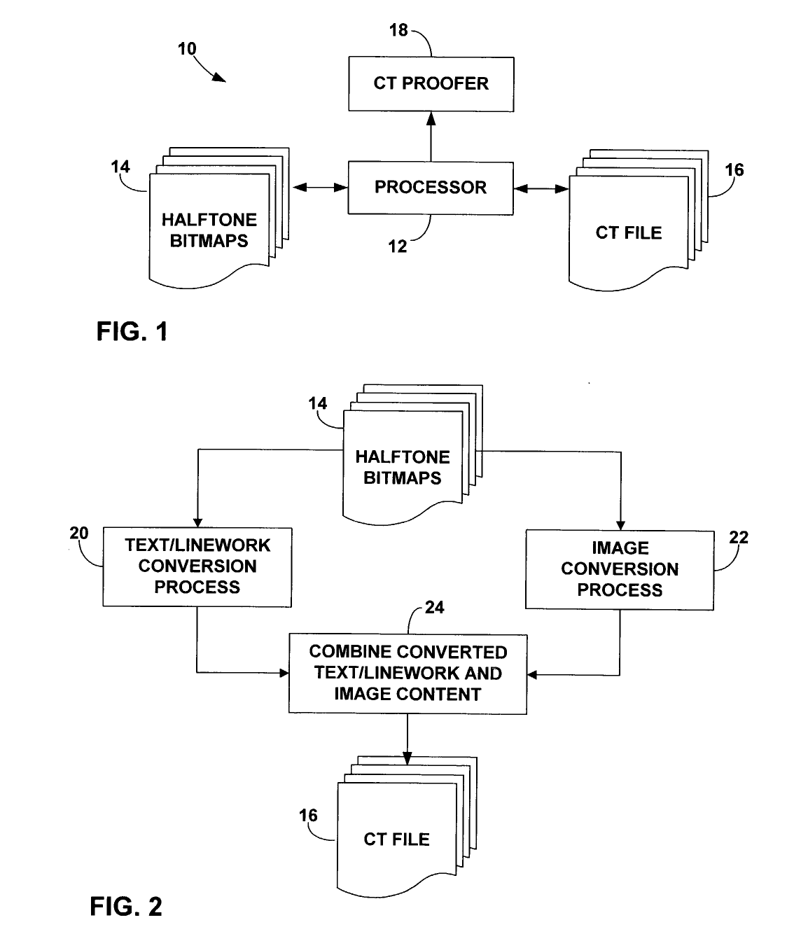

FIG. 1 is a block diagram of a proofing system 10 that converts halftone bitmaps to continuous tone representations. As shown in FIG. 1, a processor 12 converts halftone bitmaps 14 to produce continuous tone (CT) representations. In addition to performing the conversion, processor 12 may apply the CT representations to drive a print engine in a CT proofer 18 to form an image on an image output medium. The print engine may include, for example, an inkjet or electrophotographic printing device.

Processor 12 implements a conversion technique that promotes preservation of continous tone geometric information from the halftone bitmaps. In this manner, the conversion technique implemented by processor 12 can enhance the accuracy of continuous tone proofs produced by CT proofer 18. In addition, the conversion technique may provide a number of performance advantages that address image quality and processing issues associated with halftone to continuous tone conversion.

Processor 12 may take the form of a programmable microprocessor, e.g., within a personal computer or workstation. In this case, processor 12 may execute a set of instructions that drive the conversion process. Alternatively, the functionality of processor 12 could be achieved by an ASIC, FPGA, or other logic devices or circuitry configured to perform some or all of the tasks associated with the conversion process.

In some embodiments, processor 12 may execute the conversion process in the context of a color proofing application, color management system, or combination thereof. For example, processor 12 may apply color management processes. Alternatively, processor 12 may be used as a conversion server to perform halftone to continuous tone conversion for different devices.

When an original CT image is screened to produce halftone bitmaps 14, amplitude information in the CT data is encoded spatially in an arrangement of halftone bits. Depending on the ratio of the CT and halftone resolutions and other factors, varying degrees of information may be lost due to spatial encoding. Ideally, a process for converting halftone bitmaps 14 to corresponding CT representations 16 should restore the original CT data, i.e., the data for the original CT image represented by the halftone bitmap, within the limitations of this lost information.

Simply downsampling halftone bitmaps 14, however, with or without interpolation, can lead to significant false moiré in the image regions of the resulting CT representations 16 due to the high spatial-frequency content of the halftone bitmaps. The high spatial frequency content is largely due to the halftone dot structures in halftone bitmaps 14, which produce moiré mainly in image regions, rather than in text/linework regions, of a page. Global application of a bandwidth limiter, such as a blur or low pass filter, before downsampling, can reduce and even eliminate moiré in the image regions. However, bandwidth limitation tends to make text/linework regions fuzzy, i.e., less sharp, and is therefore undesirable for global application.

As a further concern, the use of stochastic screening in halftone bitmaps 14, e.g., via dispersed-dot methods, generally requires different conversion processing than conventionally screened files to maximize image quality. Accordingly, different types of screening can undermine the effectiveness of the halftone to continuous tone conversion process.

The large size of the halftone bitmaps 14 may raise an additional processing concern. For example, a set of high-resolution screened bitmaps for 8-up CMYK pages may represent over 27 billion pixels and require up to 3.5 gigabytes of storage for uncompressed data. Consequently, from a time and computing standpoint, it may be desirable to limit the number of operations required for halftone to continuous tone conversion.

The halftone to continuous tone conversion technique implemented by processor 12 may offer performance advantages that address the concerns discussed above. In general, the conversion technique resolves the competing interests in band limiting image regions to remove halftone dot structure while avoiding band limiting of text/linework regions to maintain sharpness. In particular, the conversion technique may involve the application of different conversion processes to text/linework and image regions of the page defined by halftone bitmap 14.

For example, the conversion process for image regions defined by bitmaps 14 may involve application of bandwidth limitation, e.g., a blur filter or low pass filter, to remove halftone dot structures prior to downsampling. On the contrary, processor 12 may apply a different conversion process for text/linework regions defined by bitmaps 14 that excludes bandwidth limitation in order to avoid introduction of fuzziness to text/linework regions. Again, the term “text/linework” region refers to a region that contains either text or linework, or both.

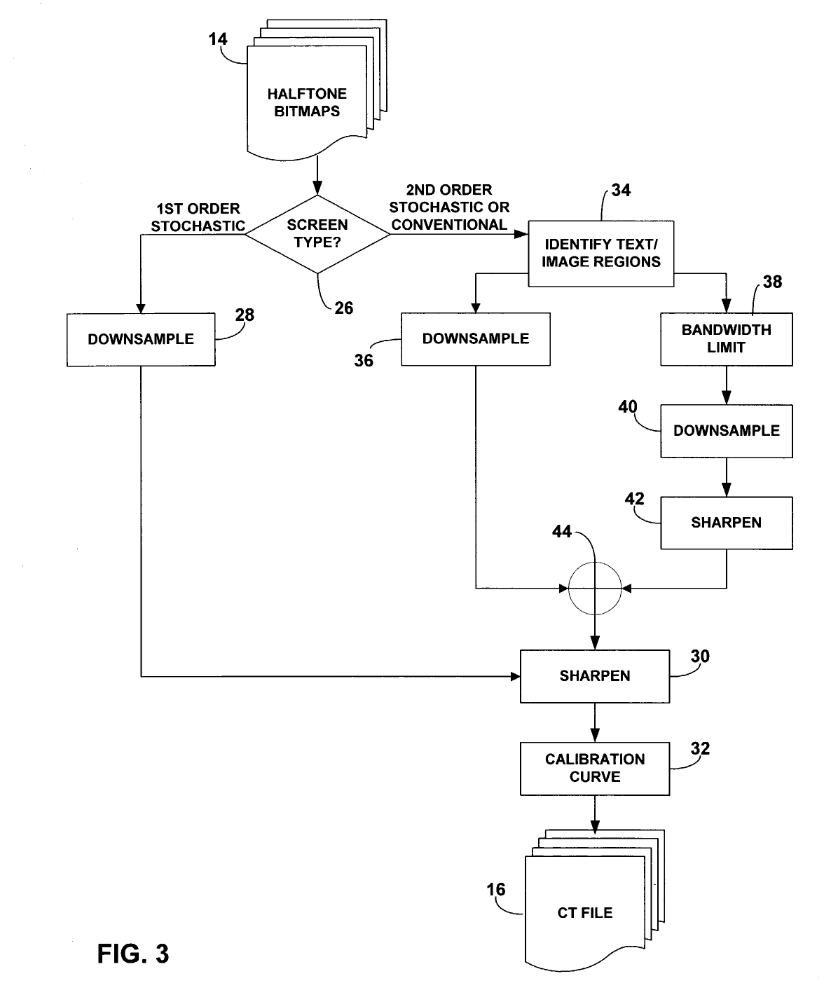

FIG. 2 is a flow diagram illustrating conversion of halftone bitmaps 14 to continuous tone representations 16 using different conversion processes 20, 22 for text/linework and image regions. As shown in FIG. 2, processor 12 applies a text/linework conversion process 20 to text/linework regions of the page content defined by halftone bitmaps 14. In addition, processor 12 applies an image conversion process 22 to image regions of the page content defined by halftone bitmaps 14. Processor 12 then forms a combination 24 of the converted text/linework regions and the converted image content to produce a continuous tone representation 16. Application of different conversion processes 20, 22 to the text/linework and image regions promotes restoration of original continuous tone geometric information from halftone bitmaps 16 in the image regions while maintaining the sharpness of the text/linework regions.

For example, the conversion process 22 for image regions may involve application of bandwidth limitation to remove halftone dot structures present in the halftone bitmaps 14 prior to downsampling. In particular, processor 12 may apply a blur filter or low pass filter prior to downsampling to remove higher spatial frequency components from the halftone bitmaps 14. For the text/linework regions, however, processor 12 applies a conversion process 20 that performs downsampling without bandwidth limitation in order to avoid introduction of fuzziness to the text/linework regions. In other words, processor 12 preferably does not apply a blur filter, low pass filter, or other band limiter to the text/linework information. In this manner, processor 12 handles text/linework information differently from image content, thereby promoting enhanced image quality and content accuracy.

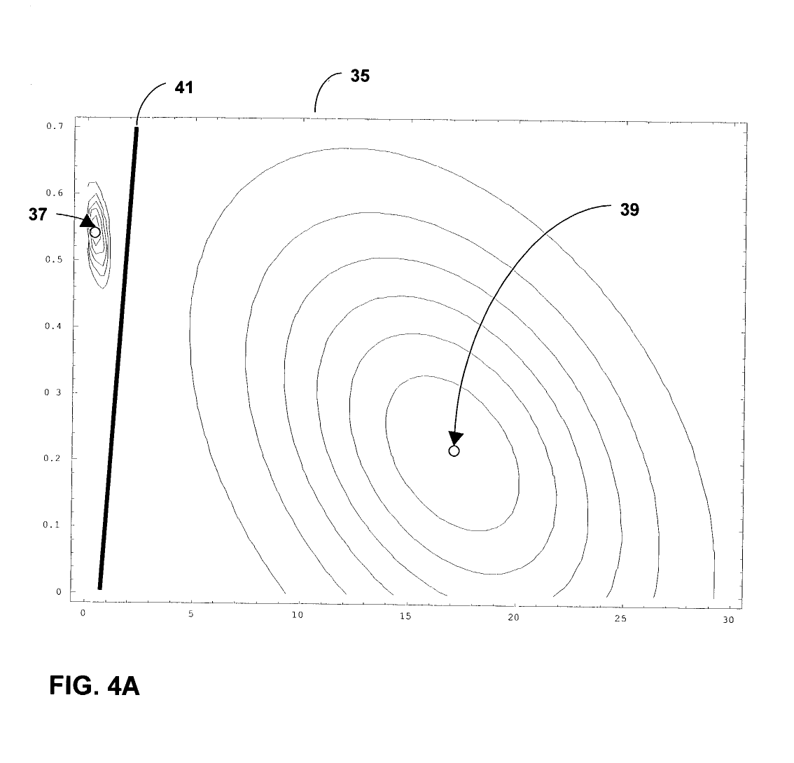

FIG. 3 is a flow diagram illustrating the conversion technique of FIG. 2 in further detail. As shown in FIG. 3, processor 12 determines the type of halftone screening (26) applied to halftone bitmaps 14. If the screening type is first order stochastic, elimination of halftone dot structures is less of a concern. Accordingly, for first order stochastic screening, processor 12 may apply a common conversion process to the entire image without the need to distinguish text/linework and image regions. In particular, processor 12 may simply apply a downsampling process (28) to halftone bitmaps with first order stochastic screening. Processor 12 then may apply a sharpening process (30) to the downsampled image, followed by application of a calibration curve (32), to produce CT representation 16. Techniques for determining the type of halftone screening associated with halftone bitmaps 14 will be described in greater detail below.

For second order stochastic and conventional screening, processor 12 analyzes the image defined by halftone bitmaps 14 and identifies text/linework and image regions (34), as described above, and applies different conversion processes to those regions. Processor 12 may use a variety of analysis techniques to distinguish text/linework and image regions of a page, as will be described in greater detail below. In general, the analysis techniques may involve, for example, connected component analysis to identify regions of contiguous pixels, followed by pixel count analysis, histogram analysis, or a combination thereof to classify the connected components as either a text/linework region or an image region. Other techniques for identification of text/linework regions and image regions, including a variety of image segmentation techniques such as thresholding, edge analysis, region analysis, connectivity-preserving relaxation, and the like, also are conceivable.

Typical classification processes accept a “feature vector,” or set of measures, from some token which is to be classified and assign one of M labels, or classifications, to it. The feature vector is a point in an N-dimensional feature space. The classifier essentially partitions this N-dimensional space into mutually exclusive hyper-volumes with each hyper-volume having an associated label. The behavior of the classifier is therefore defined by the boundaries of these hyper-volumes. The boundaries may be established either automatically, typically via an algorithm that makes use of training tokens, or by ad hoc procedures such as manual specification.

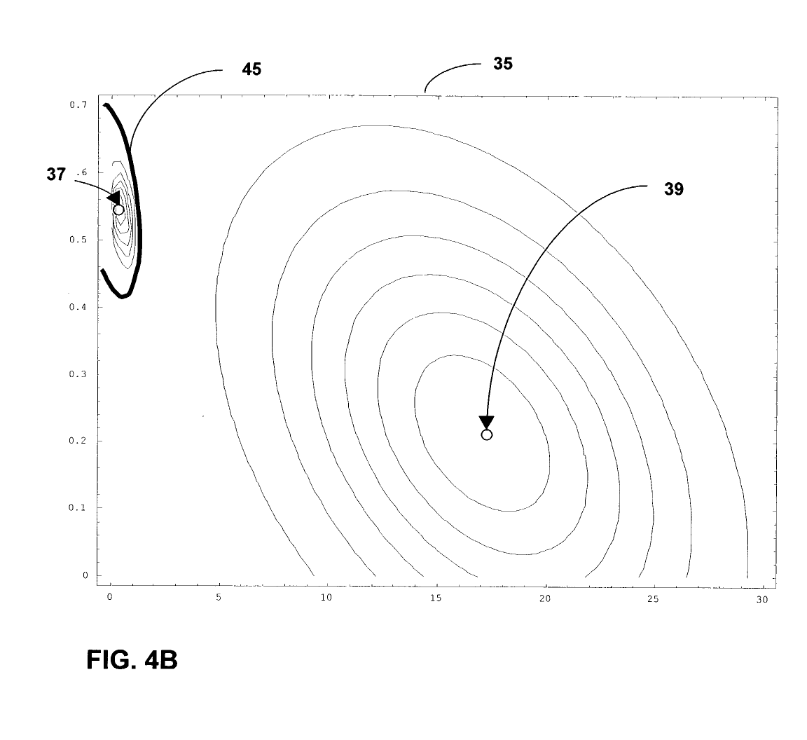

FIGS. 4A and 4B are diagrams illustrating manually and automatically determined decision boundaries in a two-dimensional feature space. As shown in FIGS. 4A and 4B, if the tokens to be classified are connected image regions, and the feature vectors have two components, namely the component's pixel count and the lowest bucket count of the normalized grayscale histogram, then there is an (N=) 2-D feature space 35 which must be divided into mutually-exclusive areas associated with each of the (M=) 2 classes (text/linework or image).

The boundaries between these areas are lines 41 or curves 45 in the 2-D plane of feature space 35, partitioning feature space 35 into regions most closely associated with the distribution 37 of members of the text/linework class or with the distribution 39 of members of the image class. Note that reference numbers 37 and 39 refer generally to a cluster of distribution members in the text/linework class and image class, respectively. These boundaries 41 and 45 may be set manually based on domain knowledge, i.e., an ad hoc method. They may alternatively be set through the use of automated methods such as Bayesian or neural network classification schemes with parameters derived from training tokens. Classification techniques based on Bayesian decision theory and neural network methods are described, for example, in Chapters 2 and 6, respectively, of Pattern Classification, Richard O. Duda et al., Wiley-Interscience, 2nd edition, 2000.

With further reference to FIG. 3, for text/linework regions, processor 12 downsamples (36) the halftone bitmap data without application of a bandwidth limiter, thereby preserving sharpness in the text/linework. For image content regions, however, processor 12 applies a bandwidth limit (38), such as a low pass filter or blur filter, thereby removing high spatial frequency information and, in particular, the halftone dot structure. Processor 12 then downsamples (40) the image content and optionally applies a sharpening process (42).

Following downsampling of text/linework regions and bandwidth limiting/downsampling/sharpening of image regions, processor 12 combines (44) the resulting text/linework and image content to form a composite image. In application, processor 12 may apply downsampling (36) to one version of the entire image for text/linework region processing, and perform bandwidth limiting (38), downsampling (40) and sharpening (42) on another version of the entire image for image region processing. Processor 12 then may, using the classification (34), form a mask corresponding to the image region from the bandwidth limited, downsampled and sharpened image and, using a stencil filter or switch (44), replace those pixels in the downsampled image (36) corresponding to the image regions with the bandwidth limited/downsampled/sharpened content (42) to obtain a final continuous tone image 16. Processor 12 may apply a sharpening process (30) to the overall composite image, followed by application of a calibration curve (32). In this manner, processor 12 produces CT representation 16 by converting text/linework regions and image regions defined by halftone bitmaps 14 using different conversion processes.

Processor 12 may determine a number of parameters for optimal processing based on the screening type and frequency of halftone bitmap 14. For typical resolutions and screen rulings, e.g., 2400 dots per inch (dpi) bitmaps with 150 line ruling, the band limiting filter kernel dimensions should be large, e.g., on the order of 32 pixels in diameter. As a result, it may be necessary to employ a computationally efficient method of band limiting, or “spatial filtering.” An example of a computationally efficient band limiting method is described in the article “Fast Convolution With Packed Lookup Tables” by Wolberg and Massalin, in Graphics Gems IV, Paul Heckbert, ed., Academic Press, 1994, pages 447-464. As another example, band limiting of image regions can be achieved by multiplying the Fast Fourier Transform (FFT) for the image with the FFT for the filter kernel. In addition, downsampling of the halftone image data can be achieved by cropping the resulting FFT. As an illustration, if the original FFT dimension was 1024 and a scale reduction of 8 is desired, after proper band limiting, the 128 lowest frequency values may be extracted from the original FFT. The extracted frequency values represent the FFT of the downsampled image.

Another operation that can be applied in the Fourier domain is sharpening. In particular, sharpening can be achieved for image regions by multiplying the cropped FFT, discussed above, with the FFT of an edge enhancement kernel.

For larger images, the Fourier processing may be performed on a block-by-block basis with an optimal block size determined by performance profiling of the particular FFT implementation. Advantageously, the spatial filtering FFT(s) need to be computed only once and may be reused for each image block. Finally, as with any block-based FFT filtering, appropriate steps, such as overlap-add or overlap-save methods, should be taken to avoid the effects of circular convolution, as discussed in detail in Digital Signal Processing, A. V. Oppenheim and R. W. Schafer, Chapter 3, 1975.

Other techniques of downsampling with band limiting may involve scaling the image down to a very small size and then back up to the desired CT resolution, downsampling the halftone bitmap 14 in stages, applying a relatively small blur filter at each stage, or using block-based FFT methods.

Processing of text/linework regions may involve basic downsampling techniques. High-resolution text or linework image elements usually take the form of relatively extended solid areas, and tend to have less high-spatial frequency energy than halftone image regions. These text/linework regions may therefore be downsampled in one pass using techniques such as bilinear or bicubic filtering. Edge enhancement may optionally be applied to text/linework regions following downsampling, e.g., to restore text character definition.

To permit application of different conversion processes to text/linework and image regions, processor 12 first identifies the text/linework and image regions. In particular, processor 12 implements an automated process for classifying image regions as containing either text/linework content or image content. A variety of image classification techniques are possible. To avoid excessive computation, however, it may be desirable to use image classification techniques that are both robust and computationally efficient. For purposes of illustration, it will be assumed that halftone bitmap conversion is applied separately to each color plane of a multi-color halftone image. In this case, image vs. text/linework classification information is not shared across the image planes. In some embodiments, however, more sophisticated methods that combine measures from all color channels are possible.

One exemplary method of classifying regions as text or imagery is by thresholding the pixel count of connected components in a binary representation of a blurred and downsampled image. The blurred and downsampled image provides a reasonable continuous-tone image for analysis and classification purposes. Processor 12 thresholds the resulting image such that any pixel that is different from white is turned black in order to obtain a binary image for connected component analysis (CCA). The CCA labels groups of pixels in a binary image that are connected through at least one of n neighbors of any pixel in the group; n=4 or n=8 connectivity is typical for 2-D image connected component analysis. Once the connected components are identified, they may be classified as either text/linework or image content on the basis of the number of pixels in the component, a histogram analysis of the continuous tone image pixels within the component, some combination of both approaches, or by other methods such as Bayesian classification as described above.

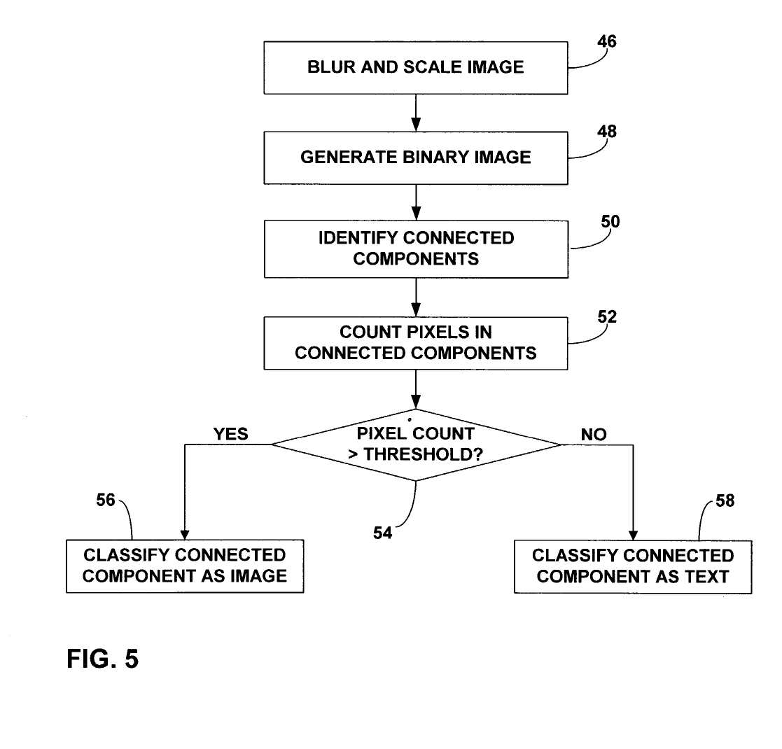

FIG. 5 is a flow diagram illustrating application of connected component analysis and pixel counting to distinguish text/linework regions and image regions. As shown in FIG. 5, the technique involves blurring and scaling, i.e., downsampling, the image defined by halftone bitmap 14 (46) to produce a continuous tone image. Thresholding is then applied, as discussed above, to the image to produce a binary image (48). Upon identification of connected components (50), the technique involves counting pixels within the connected components (52). If the pixel count exceeds a threshold (54), the connected component is classified as an image region (56). In this manner, the technique tends to classify a connected component in terms of its size, with the observation that connected text/linework regions typically will be smaller than image regions. If the pixel count is less than the threshold (54), the connected component is classified as a text/linework region (58).

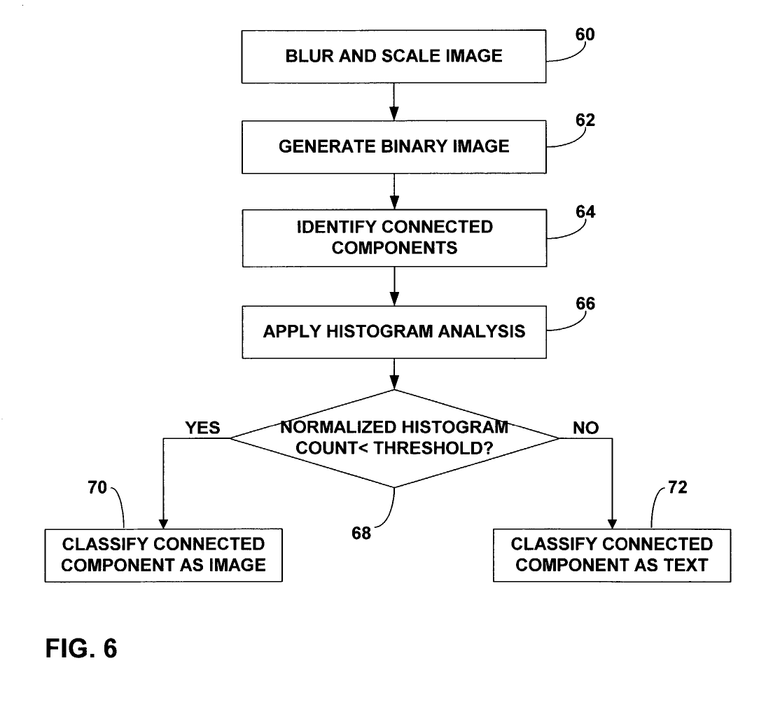

FIG. 6 is a flow diagram illustrating application of connected component analysis and histogram analysis to distinguish text/linework regions and image regions. Like the technique of FIG. 5, the technique of FIG. 6 involves blurring and scaling the image defined by halftone bitmap 14 (60) to produce a continuous tone image. Thresholding is then applied, as discussed above, to the image to produce a binary image (62). Upon identification of connected components (64), the technique involves application of histogram analysis to the connected components (66). Notably, the threshold is applied to the gray scale values of the original blurred and scaled pixel values rather than to the binary values of the binary image. Hence, the binary image is used as the tool to identify the connected components. The classification technique, however, involves generation of a histogram of gray scale values for pixels within each connected component. If the normalized histogram count for a given connected component is below a threshold (68), the connected component is classified as an image region (70). If the normalized histogram count is greater than the threshold (68), the connected component is classified as a text/linework region (72). In some embodiments, the connected component mask may be obtained from a blurred version of the halftone image even though the histogram may be derived from the non-blurred image or, alternatively, histogram measures can be obtained from both blurred and non-blurred images.

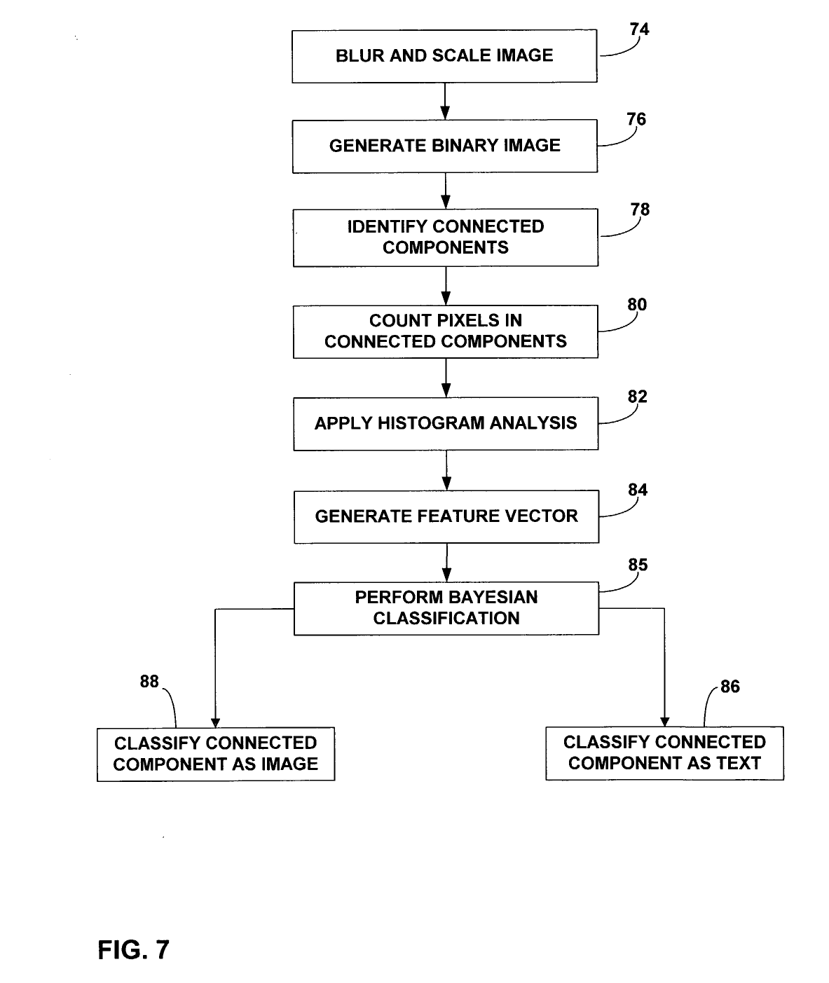

FIG. 7 is a flow diagram illustrating application of connected component analysis, with pixel counting and histogram analysis used as features in a feature vector for Bayesian classification to distinguish text/linework regions and image regions. The technique illustrated in FIG. 7 involves application of both pixel counting and histogram analysis to provide heightened confidence in the classification of image and text/linework regions. Accordingly, like the techniques of FIGS. 5 and 6, the technique of FIG. 7 involves blurring and scaling the image defined by halftone bitmap 14 (74) to produce a continuous tone image. Thresholding is then applied, as discussed above, to the image to produce a binary image (76).

Upon identification of connected components (78), the technique involves counting the number of pixels within each connected component (80), and application of histogram analysis to the connected component (82), to generate a feature vector (84). With Bayesian classification (85), if the feature vector defined by the pixel count and the normalized histogram falls in the text partition of the feature space, the connected component is classified as a text/linework region (86). Otherwise, the connected component is classified as an image region (88).

An alternative classification scheme may involve extracting the high resolution bitmap data within the extent of the connected component, computing a few samples of the FFT of this data near the previously-determined screen ruling and angle, and applying a threshold or making the FFT data an element of the feature vector. If the value is high, then there is a lot of energy at this spatial frequency so it should be halftoned image data. Alternatively, if the value is small, the subject data is probably text.

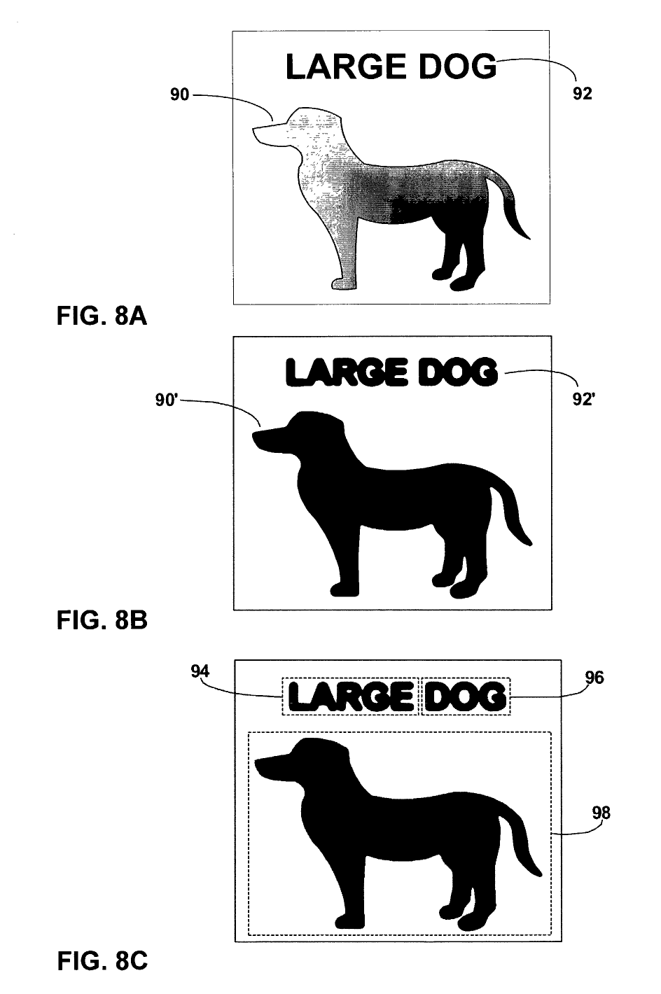

FIGS. 8A-8C are diagrams illustrating application of connected component analysis to an exemplary image. FIG. 8A conceptually illustrates an image of a dog 90 with the caption “LARGE DOG” 92. Of course, FIG. 8A may include a background and other image elements. For simplicity, however, FIG. 8A depicts dog 90 as an image region with pixel values that extend over a range of gray scale values, and caption 92 as a text/linework region largely characterized by letters presented by pixel values with a common gray scale value.

To convert a halftone bitmap representative of the image of FIG. 8A, the technique described herein may first involve generation of a binary image, as shown in FIG. 8B. Again, the technique involves thresholding a blurred and downsampled representation of the halftone bitmap of FIG. 8A such that any pixel that is different from white is turned black in order to obtain a binary image containing image region 90′ and text/linework region 92′ for connected component analysis (CCA). As a result of this process, the image of FIG. 8B includes either 0 values or 1 values to facilitate CCA.

The CCA labels groups of pixels in a binary image that are connected through at least one of n neighbors of any pixel in the group; n is typically 4 or 8. The result is the image of FIG. 8C. In particular, the CCA breaks down the image into connected component 94 containing the text “LARGE,” connected component 96 containing the text “DOG,” and connected component 98 containing the image of the dog.

Upon identification of connected components, the conversion technique may involve application of pixel count or histogram analysis to identify text/linework and image regions, as discussed above with respect to FIGS. 5, 6 and 7. Histogram analysis, in particular, may begin with accumulation of a histogram of gray levels for pixels in the blurred and scaled image within the boundaries of a given connected component.

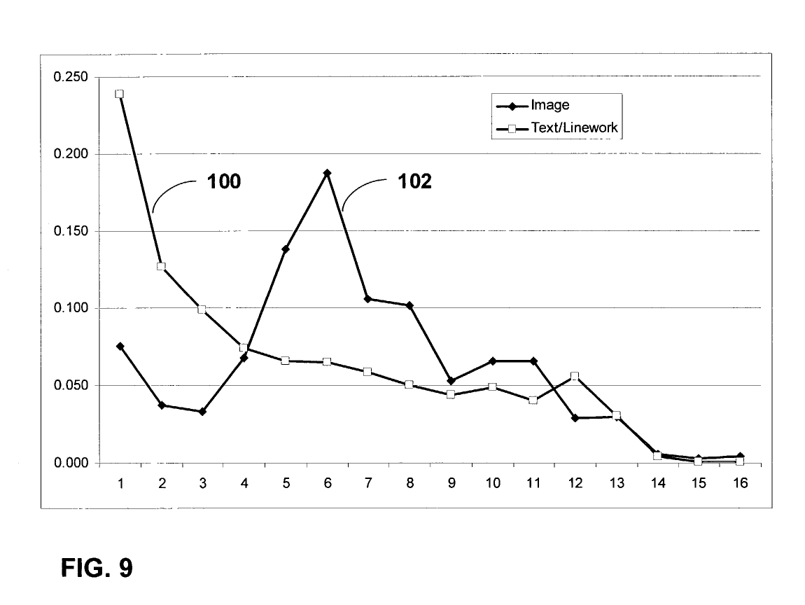

FIG. 9 is a graph illustrating normalized histograms for connected components in an exemplary image. Normalized histograms are computed as typical histograms by counting the number of inputs within each defined range or bucket, and then normalizing these counts by dividing by the total number of inputs. Shown in FIG. 9 are a histogram 100 for an exemplary connected component containing text/linework and a histogram 102 for an exemplary connected component containing imagery. The image histogram 102 exhibits a peak near the mid-tones or middle gray levels, while the text/linework histogram 100 presents an increased distribution at the lower end of the gray level range. Classification metrics based on the histogram for a connected component may be based on the percentage of pixels in a lower band of gray levels, a ratio of pixel counts such as the number of pixels in the lowest bands compared to the number of pixels in a middle band, or the normalized histogram counts may be used directly as a subset of elements in a feature vector.

After blurring, text/linework components will be dominated by pixels near gray levels 0, possibly with some rolloff due to the blur and scaling. As a result, the histograms for text/linework regions should favor the lowest gray level bands. In contrast, images should generally have a more even distribution of gray levels or peaks in the midtones. Again, a variety of metrics may be used to distinguish text/linework and image components based on the histogram data. As examples, classification may rely on percentages of pixels in broad gray level bands, ratios of percentages, or directly on the vector of histogram values.

Metrics such as connected component pixel count and normalized histogram counts may be combined to make a decision about the classification of data within a component. Again, decision-making mechanisms such as decision trees, Bayesian discriminating functions and neural networks can be used to make decisions with increased confidence levels. For example, as discussed with respect to FIG. 7, a decision tree can be devised to make use of pixel count as first level metric followed by histogram analysis as a second level. The first level would classify components with small pixel counts as text/linework, large pixel counts as images, and intermediate counts as unknown. The second level would classify the “unknown” regions based on the component's normalized histogram count in the lowest bucket, with smaller values resulting in labeling as image content. Alternatively, both the pixel counts and histogram counts may be input to a Bayesian classifier, as in FIG. 7. In this case, the joint probability functions of the classifications and resulting discriminating function can be derived from analysis of a number of hand-labeled training samples.

The text/linework and image classification problem presents two error types: (1) text/linework identified as imagery and (2) imagery identified as text/linework. For error type (1), the misclassified text region will tend to have substantially softer edges than properly classified regions. For error type (2), in the case of misclassified image regions, the image will likely exhibit a strong false moiré. Because text classification tends to favor small regions by virtue of the pixel count analysis, however, the misclassified image regions will typically be small and the moiré may not be visible to the naked eye.

Some control over the relative frequencies of the two types of classification errors can be provided by allowing user adjustment of classification parameters such as the connected component pixel count threshold, i.e., smaller connected component pixel count threshold values favor text/linework errors over image errors while larger connected component pixel count threshold values have the opposite effect. Post-processing of the classifications, with constraint rules may eliminate some errors. For example, a constraint that prohibits classification of small image regions within large blocks of text/linework can be implemented. In extreme circumstances, the classification can be disabled at user election and the entire image can be processed as image data, resulting in uniformly soft text regions, or as text/linework, this latter choice being most useful for text and linework-only pages.

Other classification schemes, including edge detection-based schemes, spectral signatures, region analysis, connectivity-preserving relaxation, and the like may be used, but present different performance and computational efficiency issues. Edge detection schemes may involve application of the thresholded output of a Laplacian edge detector to the blurred and scaled image to form a text/linework mask. Spectral signature methods may involve analysis of the FFT of blocks of halftone bitmap data within connected components or portions thereof. The FFT can be sampled along radial lines, and the mean and variance of the one-dimensional samples computed. According to the spectral signature technique, a region can be classified as text if the variance is low and as image data otherwise. Alternatively, the technique may analyze the grid of peaks present in the spectra of halftoned images. Such peaks are relatively easy to locate when the screen ruling and angles of conventionally screened images are known.

Automated operation of the halftone bitmap to continuous tone conversion technique may further involve detection of the bitmap screening type, i.e., stochastic vs. conventional (see item 26 of FIG. 3), and determination of conventional screening parameters. First-order stochastic files, due to their dispersed dot nature, can simply be downsampled with an appropriate interpolation method, like bicubic interpolation, with no additional processing required if the input resolution is significantly higher than that of the continuous tone output, e.g., 2400 dpi in to 300 dpi out. Conventionally screened and second-order stochastic bitmaps require more sophisticated processing to obtain better image quality.

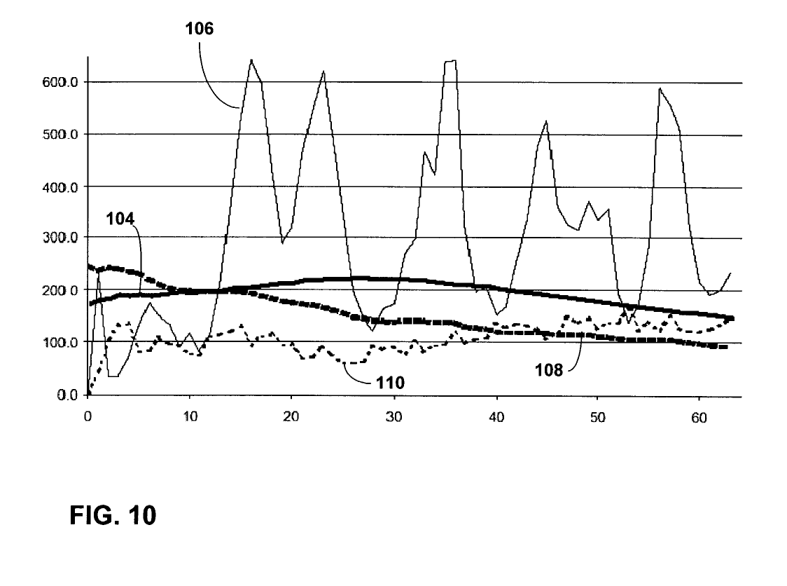

FIG. 10 is a graph illustrating radially-averaged FFT samples used to distinguish halftone screening types. The vertical axis in the graph of FIG. 10 represents FFT magnitude, whereas the horizontal axis represents distance from the center (zero frequency) of the FFT. Screening type identification may be made on the basis of spectral signatures, similar to that described above for text/linework and image classification. Specifically, the FFT magnitude of a suitable region within the image is sampled radially, and the mean and variance of these radial samples are computed. In FIG. 10, curve 108 represents the mean and curve 106 represents the variance of radially-averaged FFT samples for a conventionally-screened halftone bitmap. Curve 104 and curve 110 represent the mean and variance for radially-averaged FFT samples for stochastically-screened halftone bitmaps.

As the graph of FIG. 10 indicates, conventional screen types, that is, periodic clustered dot screens, tend to have mean spectra that roll off monotonically with increasing frequency and very high spectral variance. Stochastic screens, in contrast, have a characteristic broad peak away from zero frequency in the mean spectra and much lower spectral variance. Thresholding or some other classification of spectral variance therefore can serve as a reliable method of determining screening type of halftone bitmaps 14. Finally, this spectral screening type classification process may be repeated on a block-by-block basis if it is necessary to accept and convert pages with mixed screening.

Upon determining the screen type for a halftone bitmap, as described above, it is also desirable to identify screening parameters for conventionally screened halftone bitmaps so that internal processing, such as blur settings, may be adjusted to provide acceptable output quality. Screening parameters, such as screen ruling and screen angle, for a halftone bitmap 14 may be identified through Fourier analysis. First, identification of screen parameters may involve manually, or through an automated search, locating a region within halftone bitmap 14 that is neither near solid white nor solid black, and extracting a portion of the bitmap at this location for further analysis. Then, the identification technique computes the FFT magnitude of the extracted bitmap data, and searches the FFT magnitude for the location of the peak closest to the origin, i.e., closest to the zero frequency component of the FFT. The coordinates of the peak can be identified as (u, v).

Given the bitmap resolution D and size of the FFT N, the identification technique next computes the screen ruling R as:

$$R = \sqrt{{u}^{2} + {v}^{2}} \frac{D}{N}$$

and screen angle θ as:

$$θ = \frac{{180}^{°}}{π} arctan ( \frac{v}{u} )$$

For example, with a peak location at (u, v)=(32, 55) in an N=1024-point FFT of D=2400 dpi data, the screen ruling would be R=\sqrt{4049}(2400/1024)=149.14 lines/inch at an angle of θ=59.8°. The identified screen ruling and screen angle can be used in conversion of halftone bitmaps determined to have conventionally screening.

It may be desirable to accommodate selective conversion of reverse text/linework content. To that end, to ensure reverse text/linework is converted with the proper sharpness, the text/linework versus image classification process described herein can be applied to an inverted page image to thereby obtain a mask identifying reverse text regions. Specifically, a blurred and scaled version of the image defined by halftone bitmap 14 is thresholded at a very low pixel value so that only pixels that are 100% black remain black and the rest of the pixels are made white. This image is then inverted and passed through the connected component analysis and classification process, and regions classified as CT data are removed. The result is a reverse text/linework mask. This mask can be added to the mask from the non-inverted image analysis to obtain a final text/linework mask.

When the final text/linework mask is available, the conversion process further involves subtracting the text/linework mask from the original blurred, scaled, and thresholded image to obtain a final continuous tone image region mask. A stencil filter or “switch” then uses the continuous tone image region mask to process the complete text/linework image and replace those pixels within the text/linework image with the pixels from the continuous tone, blurred and scaled image. To avoid fuzzy halo effects around text/linework content, the continuous tone image regions should be composited over the text/linework image. The halo effects result from the strong blurring that is applied to the halftone bitmaps 14 to remove the halftone dot structure. The final composited image may optionally be sharpened (30 in FIG. 3) using an edge enhancement filter to provide a sharper overall image.

To enhance image color accuracy, in addition to geometric accuracy, it may be desirable to incorporate a calibration process within or in addition to the conversion technique. Calibration may be particularly desirable given the use of the halftone to continuous tone conversion technique in color proofing applications. In general, the conversion technique can be designed to operate on individual halftone bitmap planes of a multi-color image independently. Accordingly, the calibration process may be achieved by one-dimensional calibration curves, one for each color channel. The one-dimensional calibration curve can be applied to the composite image produced by combination of the text/linework and image regions (32 in FIG. 3). To generate the calibration curve for a given color plane, a set of continuous-tone control strips, composed of step wedges with original, known patch values {dᵢ} are processed through the applicable RIP to obtain halftone bitmaps. The resulting bitmaps for the control strips are processed through the halftone to continuous tone conversion process described herein to obtain a converted continuous tone image. The continuous tone image values are averaged within each step wedge patch to obtain converted patch values {bᵢ}. These average patch values {bᵢ} are associated with corresponding original patch values {dᵢ} and thus represent a set of sample pairs {(dᵢ, bᵢ)}. A continuous curve B(d) based on the sample pairs is then constructed such that bᵢ≈B(dᵢ). B(d) may be a piecewise function such as a cubic spline, or an analytic or polynomial function. The, the function B(d) is numerically or analytically inverted to obtain the calibration curve C(d)=B⁻¹(d). The calibration curve C(d) thereafter serves to calibrate the composite images (32 in FIG. 3) produced by the halftone to continuous tone conversion technique.

Various embodiments of the invention have been described. These and other embodiments are within the scope of the following claims.

1. A method comprising:
identifying text and image regions defined by a halftone bitmap;
converting the text region to a first continuous tone representation using a first conversion process; and
converting the image region to a second continuous tone representation using a second conversion process.

2. The method of claim 1, wherein the first conversion process includes downsampling the text region without substantial bandwidth limitation, and the second conversion process includes downsampling the image region with bandwidth limitation.

3. The method of claim 2, wherein the bandwidth limitation in the second conversion process includes application of a blur filter to the image region before downsampling the image region.

4. The method of claim 1, wherein identifying text and image regions includes:
applying connected component analysis to the image to produce connected component objects;
applying a threshold analysis to the connected component objects; and
identifying the text and image regions based on results of the threshold analysis.

5. The method of claim 4, wherein applying a threshold analysis includes:
determining whether a number of pixels within the connected component exceeds a threshold; and
identifying the connected component objects as text or image regions based on the determination.

6. The method of claim 4, wherein applying a threshold analysis includes:
applying a histogram analysis of gray levels for pixels within the connected component objects; and
identifying the connected component objects as text or image regions based on the histogram analysis.

7. The method of claim 4, wherein applying a threshold analysis includes:
determining whether a number of pixels within the connected component objects exceeds a threshold;
applying a histogram analysis of gray levels for the pixels within the connected component objects; and
identifying the connected component objects as text or image regions based on both the determination and the histogram analysis.

8. The method of claim 1, further comprising:
determining a screening type of the halftone bitmap;
converting the text region using a first conversion process that is substantially the same as the second conversion process in the event the screening type is first-order stochastic; and
converting the text region using a first conversion process that is substantially different from the second conversion process in the event the screening type is second-order stochastic or conventional.

9. The method of claim 8, further comprising determining the screening type of the halftone bitmap based on spectral content of the halftone bitmap.

10. The method of claim 1, further comprising:
determining a screening type of the halftone bitmap;
determining one or more screening parameters associated with the screening type; and
adjusting the second conversion process based on the screening parameters.

11. The method of claim 1, further comprising combining the first and second continuous tone representations to form a continuous tone image.

12. The method of claim 1, wherein identifying text and image regions includes:
applying connected component analysis to the image to produce connected component objects;
generating feature vectors for the connected component objects;
applying Bayesian analysis to the feature vectors; and
identifying the text and image regions based on results of the Bayesian analysis.

13. The method of claim 1, wherein identifying text and image regions includes:
applying connected component analysis to the image to produce connected component objects;
generating feature vectors for the connected component objects;
applying neural network analysis to the feature vectors; and
identifying the text and image regions based on results of the neural network analysis.

14. A computer-readable medium comprising instructions to cause a processor to:
identify text and image regions defined by a halftone bitmap;
convert the text region to a first continuous tone representation using a first conversion process; and
convert the image region to a second continuous tone representation using a second conversion process.

15. The computer-readable medium of claim 14, wherein the first conversion process downsamples the text region without substantial bandwidth limitation, and the second conversion process downsamples the image region with bandwidth limitation.

16. The computer-readable medium of claim 15, wherein the bandwidth limitation in the second conversion process includes application of a blur filter to the image region before downsampling the image region.

17. The computer-readable medium of claim 14, wherein the instructions cause the processor to identify text and image regions by:
applying connected component analysis to the image to produce connected component objects;
applying a threshold analysis to the connected component objects; and
identifying the text and image regions based on results of the threshold analysis.

18. The computer-readable medium of claim 17, wherein the instructions cause the processor to apply a threshold analysis by:
determining whether a number of pixels within the connected component objects exceeds a threshold; and
identifying the connected component objects as text or image regions based on the determination.

19. The computer-readable medium of claim 17, wherein the instructions cause the processor to apply a threshold analysis by:
applying a histogram analysis of gray levels for pixels within the connected component objects; and
identifying the connected component objects as text or image regions based on the histogram analysis.

20. The computer-readable medium of claim 17, wherein the instructions cause the processor to apply a threshold analysis by:
determining whether a number of pixels within the connected component objects exceeds a threshold;
applying a histogram analysis of gray levels for the pixels within the connected component objects; and
identifying the connected component objects as text or image regions based on both the determination and the histogram analysis.

21. The computer-readable medium of claim 14, wherein the instructions cause the processor to:
determine a screening type of the halftone bitmap;
convert the text region using a first conversion process that is substantially the same as the second conversion process in the event the screening type is first-order stochastic; and
convert the text region using a first conversion process that is substantially different from the second conversion process in the event the screening type is second-order stochastic or conventional.

22. The computer-readable medium of claim 21, wherein the instructions cause the processor to determine the screening type of the halftone bitmap based on spectral content of the halftone bitmap.

23. The computer-readable medium of claim 14, wherein the instructions cause the processor to:
determine a screening type of the halftone bitmap;
determine one or more screening parameters associated with the screening type; and
adjust the second conversion process based on the screening parameters.

24. The computer-readable medium of claim 14, wherein the instructions cause the processor to combine the first and second continuous tone representations to form a continuous tone image.

25. The computer-readable medium of claim 14, wherein the instructions cause the processor to identify text and image regions by:
applying connected component analysis to the image to produce connected component objects;
generating feature vectors for the connected component objects;
applying Bayesian analysis to the feature vectors; and
identifying the text and image regions based on results of the Bayesian analysis.

26. The computer-readable medium of claim 14, wherein the instructions cause the processor to identify text and image regions by:
applying connected component analysis to the image to produce connected component objects;
generating feature vectors for the connected component objects;
applying neural network analysis to the feature vectors; and
identifying the text and image regions based on results of the neural network analysis.

27. A printing device comprising:
a processor to identify text and image regions defined by a halftone bitmap, convert the text region to a first continuous tone representation using a first conversion process, and converting the image region to a second continuous tone representation using a second conversion process; and
a print engine that forms an image on image output medium based on the first and second continuous tone representations.

28. The printing device of claim 27, wherein the first conversion process downsamples the text region without substantial bandwidth limitation, and the second conversion process downsamples the image region with bandwidth limitation.

29. The printing device of claim 28, wherein the bandwidth limitation in the second conversion process includes application of a blur filter to the image region before downsampling the image region.

30. The printing device of claim 27, wherein the processor identifies text and image regions by:
applying connected component analysis to the image to produce connected component objects;
applying a threshold analysis to the connected component objects; and
identifying the text and image regions based on results of the threshold analysis.

31. The printing device of claim 30, wherein the processor applies a threshold analysis by:
determining whether a number of pixels within the connected component objects exceeds a threshold; and
identifying the connected component objects as text or image regions based on the determination.

32. The printing device of claim 30, wherein the processor applies a threshold analysis by:
applying a histogram analysis of gray levels for pixels within the connected component objects; and
identifying the connected component objects as text or image regions based on the histogram analysis.

33. The printing device of claim 30, wherein the processor applies a threshold analysis by:
determining whether a number of pixels within the connected component objects exceeds a threshold;
applying a histogram analysis of gray levels for the pixels within the connected component objects; and
identifying the connected component objects as text or image regions based on both the determination and the histogram analysis.

34. The printing device of claim 27, wherein the processor:
determines a screening type of the halftone bitmap;
converts the text region using a first conversion process that is substantially the same as the second conversion process in the event the screening type is first-order stochastic; and
converts the text region using a first conversion process that is substantially different from the second conversion process in the event the screening type is second-order stochastic or conventional.

35. The printing device of claim 34, wherein the processor determines the screening type of the halftone bitmap based on spectral content of the halftone bitmap.

36. The printing device of claim 27, wherein the processor:
determines a screening type of the halftone bitmap;
determines one or more screening parameters associated with the screening type; and
adjusts the second conversion process based on the screening parameters.

37. The printing device of claim 27, wherein the processor combines the first and second continuous tone representations to form a continuous tone image.

38. The printing device of claim 27, wherein the processor identifies text and image regions by:
applying connected component analysis to the image to produce connected component objects;
generating feature vectors for the connected component objects;
applying Bayesian analysis to the feature vectors; and
identifying the text and image regions based on results of the Bayesian analysis.

39. The printing device of claim 27, wherein the processor identifies text and image regions by:
applying connected component analysis to the image to produce connected component objects;
generating feature vectors for the connected component objects;
applying neural network analysis to the feature vectors; and
identifying the text and image regions based on results of the neural network analysis.
